(19) United States
(12) Patent Application Publication
(10) Pub. No.: US 2009/0066683 A1
(43) Pub. Date: Mar. 12, 2009

(54) POWER GENERATING MODULE, AND LIQUID CRYSTAL DISPLAY AND ELECTRONIC APPARATUS HAVING THE SAME

(76) Inventor: Jong Tae Kim, Asan-si (KR)

Correspondence Address: F. CHAU & ASSOCIATES, LLC, 130 WOODBURY ROAD, WOODBURY, NY, 11797, US

(21) Appl. No.: 12/172,525

(22) Filed: Jul. 14, 2008

(30) Foreign Application Priority Data
Sep. 7, 2007 (KR) 10-2007-0090994

(51) Int. Cl. G06F 3/038; H02J 1/10

(52) U.S. Cl. 345/211; 307/43

(57) ABSTRACT

A power generating module includes: a first power terminal to which a first voltage is supplied; a second power terminal to which a second voltage generated by a regulator is supplied; and a filtering unit including a bridge capacitor connected between the first power terminal and the second power terminal. Capacitance is shared by the bridge capacitor, and noise in output voltages from various power terminals is offset and removed, thereby stable power with minimal noise can be supplied. Signal interference of antennas close to a power generating module of a display device due to noisy output voltages can be minimized.

### CROSS REFERENCE TO RELATED APPLICATION

This application claims priority from Korean Patent Application No. 10-2007-0090994 filed on Sep. 7, 2007, in the Korean Intellectual Property Office, the disclosure of which is incorporated herein by reference in its entirety.

### BACKGROUND OF THE INVENTION

1. Technical Field

The present disclosure relates to a power generating module, a display device and an electronic apparatus having the same. More specifically, the present disclosure relates to a power generating module that includes a filtering circuit for removing noise from an output voltage, a display device and an electronic apparatus having the same.

2. Discussion of Related Art

A liquid crystal display (LCD), which is one of the most popular display devices, controls transmittance of incident light from a light source using optical anisotropy of liquid crystal molecules and polarization characteristics of polarizing plates to display a desired image. The LCD is divided into a display region where an image is displayed, and a peripheral region that is provided outside the display region. In the peripheral region, drivers are provided to drive a plurality of pixels formed in the display region. For example, there may be provided a gate driver for applying scanning signals, that is, gate signals, to the pixels, and a data driver for applying image signals, that is, data signals, to the pixels.

The LCD is widely used as a monitor in a mobile computer, because it is compatible with a mobile environment due to light-weight, slim shape, and low power consumption. The mobile computer provides communication functions, such as wireless wide area network and wireless local area network, in addition to providing a general computing function. To this end, the mobile computer has an antenna for receiving wireless signals, and a communication module for processing the wireless signals. Accordingly, by using the mobile computer, the user can conveniently enjoy a mobile computing environment without being restricted by time and space.

In a mobile computer such as a notebook, however, an antenna is disposed to be close to an LCD panel due to the limited available space. Accordingly, the reception sensitivity of the antenna can be degraded due to the presence of various power signals required for driving the LCD panel. For example, logic voltages are supplied to the gate driver and the data driver disposed outside the LCD panel. The logic voltages are supplied through interconnections that are spatially close to the antenna. For this reason, the antenna may receive noisy ripples in the logic voltages, which may result in reflection, radiation, harmonics, and distortion of the wireless signals. As a result, the communication functions may be deteriorated.

### SUMMARY OF THE INVENTION

Exemplary embodiments of the present invention provide a power generating module including a bridge capacitor connected between a plurality of power terminals to share capacitance of a plurality of power sources, so that an output voltage without noisy ripples can be supplied, and a display device having the same.

An exemplary embodiment of the present invention provides an electronic apparatus capable of reducing noise around an antenna to improve communication functions.

According to an exemplary embodiment of the present invention, a power generating module includes a first power terminal to which a first voltage is supplied, a second power terminal to which a second voltage generated by a regulator is supplied, and a filtering unit including a bridge capacitor connected between the first and the second power terminals.

The filtering unit may include an optional resistor connected in parallel with the bridge capacitor.

The power generating module according to an exemplary embodiment of the present invention may further include at least one of a first bypass capacitor that is connected to an input of the regulator, and a second bypass capacitor that is connected to an output of the regulator. In this exemplary embodiment, one end of each of the first and second bypass capacitors may be grounded, and the other end of the second bypass capacitor may be connected to the bridge capacitor.

The first voltage may include an alternating current component.

According to an exemplary embodiment of the present invention, a display device includes a display panel for displaying an image thereon, and a power generating module for supplying a plurality of driving voltages for driving the display panel. The power generating module includes a first power terminal to which a first voltage is supplied, a second power terminal to which a second voltage is supplied, and a filtering unit including a bridge capacitor connected between the first power terminal and the second power terminal.

The second power voltage may be generated by a regulator, and the first voltage may be divided and input to the regulator.

The power generating module may further include at least one of a first bypass capacitor that is connected to an input of the regulator, and a second bypass capacitor that is connected to an output of the regulator. In this exemplary embodiment, one end of each of the first and second bypass capacitors may be grounded, and the other end of the second bypass capacitor may be connected to the bridge capacitor.

The filtering unit may include an optional resistor that is connected in parallel with the bridge capacitor.

The display panel may include a liquid crystal layer.

According to an exemplary embodiment of the present invention, an electronic apparatus includes a display panel for displaying an image thereon, a power generating module for supplying a plurality of driving voltages for driving the display panel, at least one antenna provided in an outside region of the display panel, and a communication module for processing a radio signal to be received by the antenna. The power generating module includes a first power terminal to which a first voltage is supplied, and a second power terminal to which a second voltage is supplied, and a filtering unit including a bridge capacitor connected between the first power terminal and the second power terminal.

The communication module may include a first communication module for a wireless wide area network, and a second communication module for a wireless local area network.

The filtering unit may include an optional resistor that is connected in parallel with the bridge capacitor.

The display panel and the antenna may be provided in a single monitor.

### BRIEF DESCRIPTION OF THE DRAWINGS

Exemplary embodiments of the present invention will be understood in more detail from the following descriptions taken in conjunction with the attached drawings, in which:

FIG. 1 is a block diagram showing an LCD according to an exemplary embodiment of the present invention;

FIG. 2 is a block diagram showing a driving voltage generator used in the system shown in FIG. 1;

FIG. 3 is a circuit diagram showing a logic voltage generator according to an exemplary embodiment of the present invention;

FIGS. 4A and 4B are waveform charts showing voltage waveforms before and after noise filtering according to an exemplary embodiment of the present invention; and

FIG. 5 is a plan view showing a mobile computer according to an exemplary embodiment of the present invention.

### DETAILED DESCRIPTION OF EXEMPLARY EMBODIMENTS

Exemplary embodiments of the present invention will now be described in detail with reference to the accompanying drawings.

The present invention may, however, be embodied in many different forms and should not be construed as being limited to the exemplary embodiments set forth herein. Rather, these exemplary embodiments are provided so that this disclosure will be thorough and complete and will fully convey the concept of the invention to those of ordinary skill in the art. Like reference numerals refer to like elements throughout the specification.

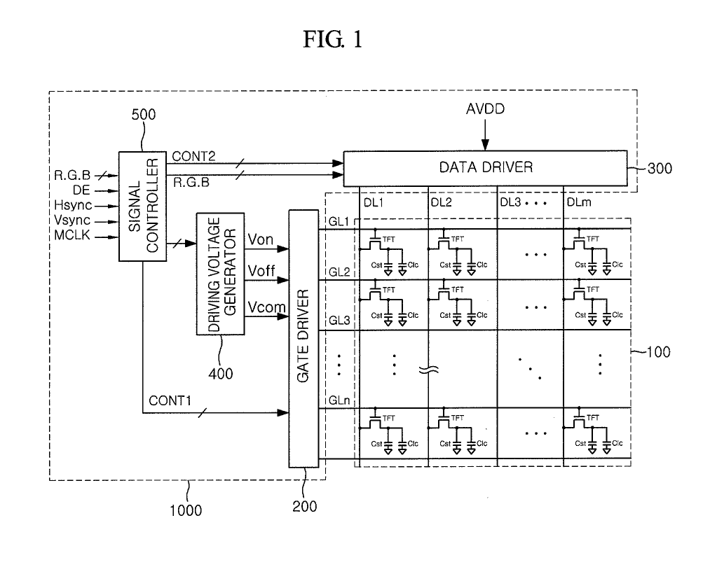

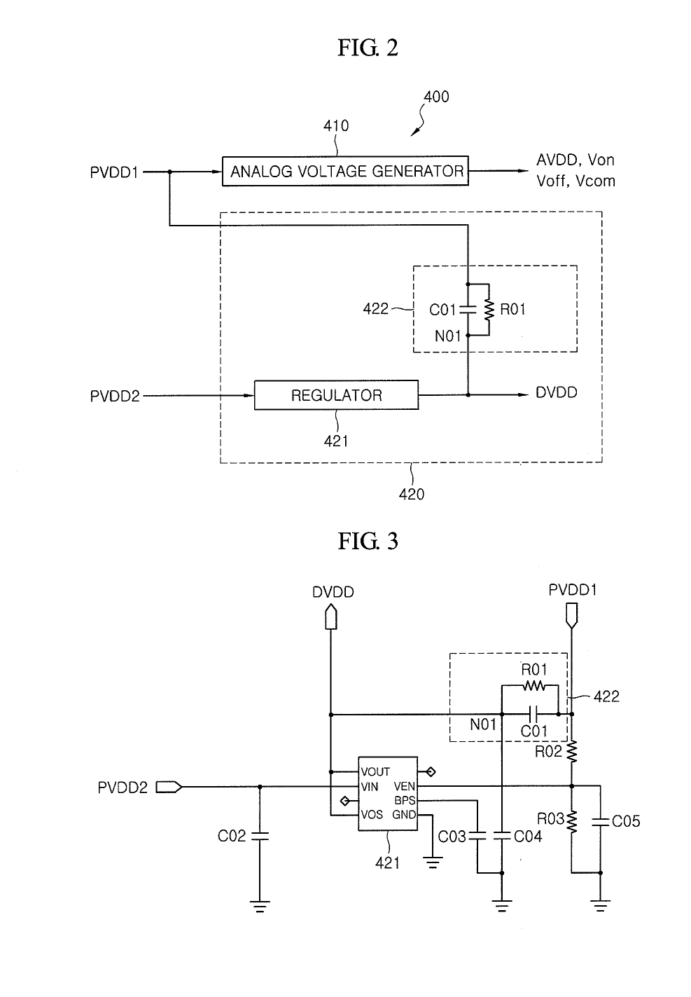

FIG. 1 is a block diagram showing an LCD according to an exemplary embodiment of the present invention. FIG. 2 is a block diagram showing a driving voltage generator used in the system shown in FIG. 1.

Referring to FIGS. 1 and 2, the LCD according to an exemplary embodiment of the present invention includes an LCD panel 100 on which a plurality of pixels are arranged in a matrix form, and a liquid crystal driving circuit 1000 for controlling the operations of the pixels.

The LCD panel 100 includes a plurality of gate lines GL1 to GLn, a plurality of data lines DL1 to DLm, and a plurality of unit pixels. The plurality of gate lines GL1 to GLn extend in one direction, and the plurality of data lines DL1 to DLm extend in a direction intersecting the plurality of gate lines GL1 to GLn. At least one end of each of the plurality of gate lines GL1 to GLn is connected to a gate driver 200, and at least one end of each of the plurality of data lines DL1 to DLm is connected to a data driver 300.

As shown in FIG. 1, each of the unit pixels includes a thin film transistor TFT and a liquid crystal capacitor Clc. The unit pixel may further include a storage capacitor Cst. The liquid crystal capacitor Clc has a lower pixel electrode, an upper common electrode, and liquid crystal interposed between the lower pixel electrode and the upper common electrode. Although not shown, a color filter is provided above the liquid crystal capacitor Clc. The pixel electrode and the common electrode are divided into a plurality of domains. Of course, the LCD panel 100 according to this exemplary embodiment is not limited to the above description, but may be implemented in various forms. That is, a plurality of pixels may be provided in the unit pixel region. In addition, the horizontal length of the unit pixel region may be longer or shorter than the vertical length. Furthermore, the unit pixel region may have various shapes, as well as a substantially rectangular shape.

The liquid crystal driving circuit 1000 for supplying signals for driving the LCD panel 100 is disposed outside the LCD panel 100 having the above-described structure. The liquid crystal driving circuit 1000 includes a gate driver 200, a data driver 300, a driving voltage generator 400, and a signal controller 500 for controlling the gate driver 200, the data driver 300, and the driving power voltage generator 400.

The signal controller 500 receives an input image signal and input control signals from an external graphic controller (not shown). The input image signal includes pixel data R, G, and B, and the input control signals include a vertical synchronizing signal Vsync, a horizontal synchronizing signal Hsync, a main clock MCLK, and a data enable signal DE. In addition, the signal controller 500 processes the pixel data R, G, and B according to the operation conditions of the LCD panel 100. In this way, the pixel data R, G, and B are converted into digital signals, are rearranged according to the pixel arrangement of the LCD panel 100, and are transmitted to the data driver 300 with corrected image characteristics. Furthermore, the signal controller 500 generates a gate control signal CONT1 and a data control signal CONT2 based on the input control signals and transmits the generated gate and data control signals CONT1 and CONT2 to the gate driver 200 and the data driver 300, respectively. The gate control signal CONT1 includes a vertical synchronization start signal for instructing the start of outputting a gate-on voltage Von, a gate clock signal, and an output enable signal. The data control signal CONT2 includes: a horizontal synchronization start signal for indicating a transmission start of the pixel data R, G, and B; a load signal for instructing applying a data voltage to a corresponding data line; an inversion signal for inverting a polarity of a grayscale voltage with respect to a common voltage; and a data clock signal.

The driving voltage generator 400 as shown in FIG. 2 generates analog voltages and logic voltages required for driving the LCD using external voltages PVDD1 and PVDD2, which are input from an external power supply (not shown). Specifically, the driving voltage generator 400 includes an analog voltage generator 410 and a logic voltage generator 420. The analog voltage generator 410 generates analog voltages for driving the LCD panel 100, including a gate-on voltage Von, a gate-off voltage Voff, and a liquid crystal driving voltage AVDD using the first external power PVDD1. The logic voltage generator 420 generates logic voltages for driving the ICs of the gate driver 200, the data driver 300, and the signal controller 500, using the second external power PVDD2. Of course, the first and second external voltages PVDD1 and PVDD2 may employ the same voltage level. Meanwhile, the driving voltage generator 400 further includes a filtering unit 422 including a bridge capacitor C01. In order to remove noise from at least one of the output voltages described above and stabilize the output power, the bridge capacitor C01 is connected between an output terminal of the corresponding voltage and a power terminal of a different voltage. The detailed configuration and operation of the filtering unit 422 will be described below.

The gate driver 200 is connected to the plurality of gate lines GL1 to GLn, and sequentially supplies the gate-on voltage Von from the driving power generator 400 to the plurality of gate lines GL1 to GLn according to the control signals from the signal controller 500. In this way, the operations of the thin film transistors TFT can be controlled.

The data driver 300 is connected to the plurality of data lines DL1 to DLm, and generates grayscale voltages using the control signals from the signal controller 500 and the liquid crystal driving voltage AVDD from the driving voltage generator 400. Then, the data driver 300 correspondingly applies the grayscale voltages to the data lines DL1 to DLm. That is, the data driver 300 converts the input digital pixel data R, G, and B into analog data signals based on the liquid crystal driving voltage AVDD, and outputs the converted analog data signals. In this exemplary embodiment, the data driver 300 may generate a set of grayscale voltages having different polarities, that is, a positive grayscale voltage and a negative grayscale voltage, and apply data signals, of which polarities are inverted by the inversion signal from the signal controller 500, to the data lines DL1 to DLm using the generated grayscale voltages. That is, in order to prevent the pixels from being deteriorated, a set of positive and negative data signals with respect to the common voltage applied to the common electrode may be alternately applied to each dot, each line, each column, or each frame.

The signal controller 500, the driving voltage generator 400, the gate driver 200, and the data driver 300 are integrated into an integrated circuit (IC), and the IC is mounted on a printed circuit board (PCB) (not shown). The printed circuit board is electrically connected to the LCD panel 100 through a flexible printed circuit board (FPC) (not shown). The gate driver 200 and the data driver 300 may be provided in the lower substrate of the LCD panel 100. In addition, the gate driver 200 may be formed directly on the lower substrate of the LCD panel 100. That is, the gate driver 200 may be formed at the same time when the thin film transistor TFT is formed on the lower substrate.

As described above, the driving voltage generator 400 further includes the filtering unit 422 including the bridge capacitor C01. In order to remove noise from at least one of the plurality of output voltages and stabilize the output power, the bridge capacitor C01 is connected between the output terminal of the corresponding voltage and the power terminal of a different voltage. The term “power terminal” used herein refers to either an input terminal of various voltages input to the driving voltage generator 400 or an output terminal of various voltages generated by the driving voltage generator 400. For example, in this exemplary embodiment, the logic voltage generator 420 is provided with the filtering unit 422 that removes noise from a logic voltage DVDD output from a regulator 421 and the first external voltage PVDD1 input to the analog voltage generator 410 and stabilizes the logic voltage DVDD and the first external voltage PVDD1. The filter unit 422 is connected between one power terminal from which the output voltage DVDD of the regulator 421 is output, and the other power terminal to which the first external voltage PVDD1 is input, thereby sharing capacitance. The detailed configuration and operation of the filter unit 422 will be described below.

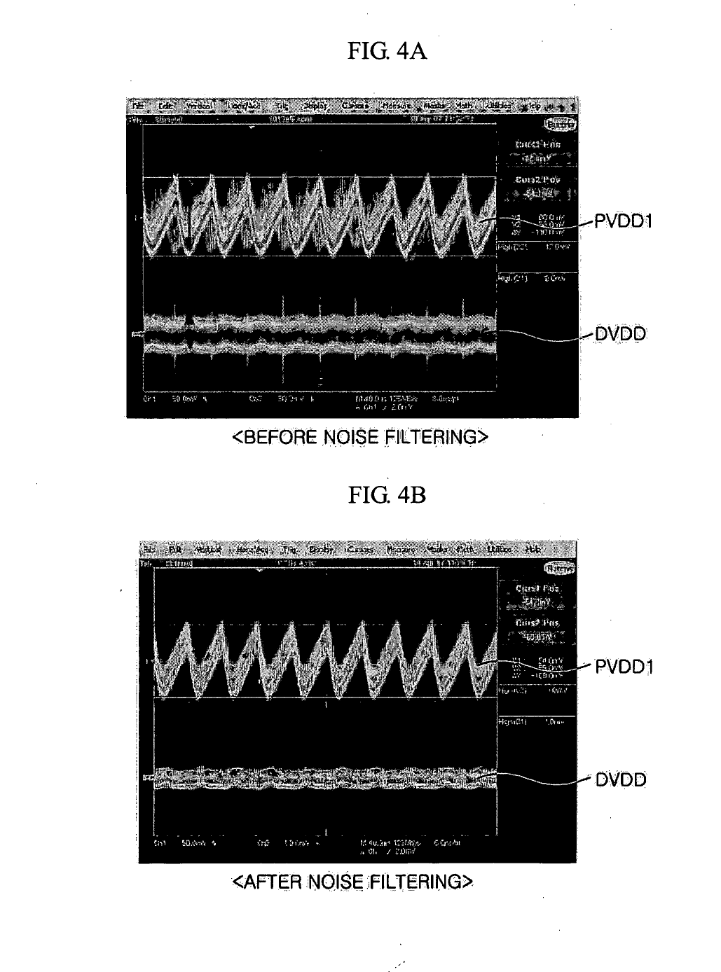

FIG. 3 is a circuit diagram showing a logic voltage generator according to an exemplary embodiment of the present invention. FIGS. 4A and 4B are waveform charts showing voltage waveforms before and after noise filtering according to an exemplary embodiment of the present invention.

Referring to FIG. 2, the logic voltage generator 420 includes a first power terminal, a second power terminal and the filtering unit 422. The first power terminal is provided with a first voltage, for example, the first external voltage PVDD1 that is input to the analog voltage generator 410. The second power terminal outputs a second voltage, that is, the logic voltage DVDD, from the regulator 421. The filtering unit 422 is connected between the first power terminal and the second power terminal to share capacitance therebetween.

Referring to FIG. 3, the regulator 421 is manufactured as a single IC including an enable terminal VEN, an input terminal VIN, an output terminal VOUT, a bypass terminal BPS, a ground terminal GND, and a sensing terminal VOS. The regulator 421 is driven by power that is input through the enable terminal VEN. The regulator 421 steps down the voltage level of the second external voltage PVDD2 input through the input terminal VIN, and outputs the stepped-down voltage through the output terminal VOUT. In addition, the regulator 421 receives the output voltage of the output terminal VOUT through the sensing terminal VOS and adjusts the output voltage of the output terminal VOUT to be substantially constant. Furthermore, a first bypass capacitor C02 that is grounded may be connected to the input terminal VIN of the regulator 421, and second bypass capacitors C03 and C04 that are grounded may be connected to the output terminal VOUT thereof. The first bypass capacitor C02 filters and removes a ripple component of the input voltage fed to the regulator 421, that is, the second external voltage PVDD2. The second bypass capacitors C03 and C04 filter and remove a ripple component of the output voltage from the regulator 421, that is, the logic voltage DVDD. The first external voltage PVDD1 that is input to the analog voltage generator 410 is divided by resistors R02 and R03, and is used as the driving voltage for the regulator 421.

The filtering unit 422 includes the bridge capacitor C01 connected between the first power terminal and the second power terminal. Capacitance of the bridge capacitor C01 may be in a range of approximately picofarads (pF) to nanofarads (nF). The bridge capacitor C01 offsets and removes noisy ripple components of the voltage PVDD1 at the first power terminal and the voltage DVDD at the second power terminal through an interaction with both. In addition, the filtering unit 422 may further include an optional resistor R01 connected in parallel with the bridge capacitor C01. The optional resistor R01 is opened while the regulator 421 operates, and has a predetermined resistance while the regulator 421 does not operate. In this exemplary embodiment, the optional resistor R01 may have a low resistance of approximately 0 ohms while the regulator 421 does not operate.

The first external voltage PVDD1 applied to the first power terminal is divided by the resistors R02 and R03 and then is input to the enable terminal VEN of the regulator 421. Accordingly, the regulator 421 is driven, and then the second external voltage PVDD2 input to the input terminal VIN is stepped down and output through the output terminal VOUT. The voltage output from the output terminal VOUT of the regulator 421 is input to the sensing terminal VOS of the regulator 421 again as a sensing signal, such that the output level of the output terminal VOUT is adjusted to be substantially constant. The output voltage of the regulator 421, that is, the logic voltage DVDD, is stabilized by eliminating noise while being passed through the filtering unit, and then is output through the second power terminal. Because the bridge capacitor C01 is connected between the first power terminal, to which the first external voltage PVDD1 is applied, and the second power terminal, to which the logic voltage DVDD is applied, the noisy ripples of the first external voltage PVDD1 and the logic voltage DVDD are cancelled through the interaction of the bridge capacitor C01 therewith. As a result, the first external power PVDD1 output from the first power terminal and the logic voltage DVDD output from the second power terminal are stabilized as the noise is filtered and eliminated. For more efficient filtering by the bridge capacitor C01, at least one of the voltages supplied to the first and the second power terminals may have an alternating current component. In this exemplary embodiment, the first external voltage PVDD1 that is applied to the first power terminal has an alternating current component.

From FIGS. 4A and 4B, it can be seen that the input voltage of the analog voltage generator 410 generated in the above-described manner, that is, the first external voltage PVDD1, and the output voltage of the logic voltage generator 420, that is, the logic voltage DVDD, are substantially free from noisy ripples and are thus stabilized. More specifically, referring to FIG. 4A, the first external voltage PVDD1 and the logic voltage DVDD before noise filtering show severe up-and-down swings with respect to the central waveform due to noisy ripples. Meanwhile, referring to FIG. 4B, the first external voltage PVDD1 and the logic voltage DVDD after noise filtering are substantially free from noisy ripples and converge to the central waveform, and therefore show stabilized waveforms with only a narrow up-and-down swing.

The liquid crystal driving voltage AVDD, the gate-on voltage Von, the gate-off voltage Voff, and the common voltage Vcom are generated based on the stable first external voltage PVDD1 having minimal noise and are supplied to the LCD panel 100. In addition, the stable logic voltage DVDD having minimal noise is supplied to the various ICs of the gate driver 200, the data driver 300, and the signal controller 500, so that the LCD can stably operate.

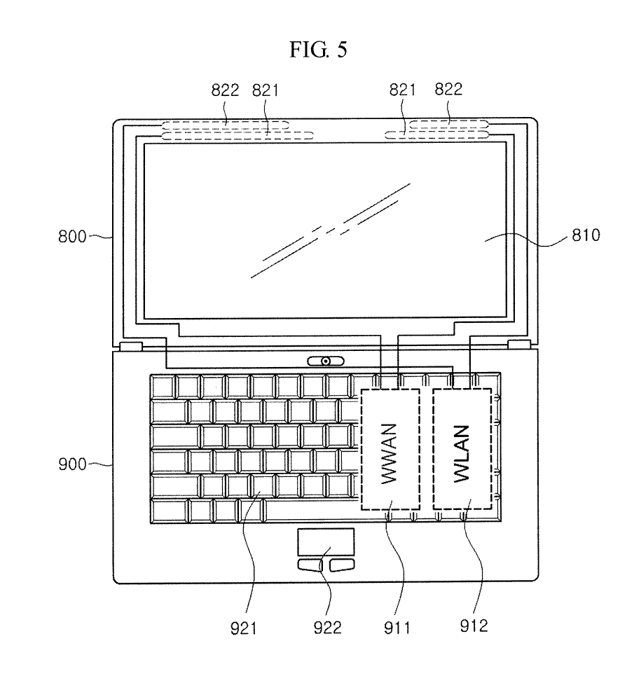

FIG. 5 is a plan view showing a mobile computer according to an exemplary embodiment of the present invention.

Referring to FIG. 5, the mobile computer according to an exemplary embodiment of the present invention includes: a monitor 800 including antennas 821 and 822 provided outside a screen to receive radio signals; and a main body 900 including communication modules 911 and 912 embedded therein for radio signal processing. The mobile computer is provided in the form of a notebook computer, the monitor 800 and the main body 900 being incorporated into a single structure.

The monitor 800 may employ the LCD panel 100 that has been described in the above-described exemplary embodiment. Accordingly, a liquid crystal driving circuit (not shown) for driving the LCD panel 810 is incorporated into the main body 900. Part of the liquid crystal driving circuit may be provided outside the LCD panel 810. For example, in this exemplary embodiment, a gate driver (not shown), a data driver (not shown), and a logic voltage generator (not shown) for supplying the logic voltages to the gate driver and the data driver are disposed outside the LCD panel 810. The antennas 821 and 822 are provided outside the LCD panel 810 to receive the radio signals. For example, in this exemplary embodiment, a first antenna 821 and a second antenna 822 are provided in an upper portion of the outside of the LCD panel 810. The first antenna 821 is provided to receive signals for wireless wide area network (WWAN) fed to the communication module 911, and the second antenna 822 is provided to receive signals for wireless local area network (WLAN) fed to the communication module 912.

The communication modules 911 and 912, together with the signal processing devices, for example, various computing modules and the liquid crystal driving circuit, are disposed within the main body 900. Input devices, for example, a keyboard 921 and a mouse 922, are provided on the outside of the main body 900. The communication modules 911 and 912 include a first communication module 911 to process the signals for WWAN, and a second communication module 912 to process the signals for WLAN.

The liquid crystal driving circuit provided in the main body 900 has a power generating module (not shown) for generating and supplying various voltages for driving the LCD panel 810. The power generating module may include: an analog voltage generator for generating various analog voltages for driving the LCD panel 810; and a logic voltage generator for generating various logic voltages for driving the liquid crystal driving circuit. That is, the power generating module including the driving voltage generator 400 according to the above-described exemplary embodiment may be desirable. Various voltages generated by the analog voltage generator are supplied to the gate driver and the data driver through a first interconnection (not shown) that is disposed close to the antennas 821 and 822. In addition, various voltages generated by the logic voltage generator are supplied to the gate driver and the data driver of the LCD panel 810 through a second interconnection (not shown) that is also disposed close to the antennas 821 and 822. At this time, the various voltages generated at the analog voltage generator 410 of FIG. 2 and the logic voltage generator 420 of FIG. 2 are substantially free from noisy ripples and are stabilized, because they have been passed through the filtering circuit including the bridge capacitor. Accordingly, signal interference due to noisy ripples does not take place at the antennas 821 and 822 that are close to the first and second interconnections. Therefore, communication functions are not deteriorated. As a result, the mobile computer according to this exemplary embodiment can provide a user with a stable wireless communication environment.

Similarly to the above-described exemplary embodiment, in a case of a product having a wireless communication function, debugging by noise measurement may be performed to determine an optimum capacitance of the bridge capacitor in the power generating module. The debugging may be performed by measuring noise received by an antenna while the product is normally operating, and adjusting the capacitance of the bridge capacitor so that the measured noise falls within a tolerable range (or reference range). In an exemplary embodiment, the optimum capacitance of the bridge capacitor may be in a range of approximately picofarads (pF) to nanofarads (nF).

Although in the exemplary embodiments described above, a filtering circuit is employed to remove noise from a logic voltage DVDD used for driving an LCD panel and to stabilize the logic voltage DVDD, the present invention is not limited thereto. For example, various other voltages may be required to drive the LCD and a mobile computer according to the above-described embodiments. Accordingly, the above-described filtering circuit may be applicable to remove noise from various other voltages and to stabilize them.

Although an LCD and a mobile computer including a power generating module having the bridge capacitor connected between the plurality of power terminals have been described in the above exemplary embodiments, the invention is not limited thereto. For example, the invention may be applicable to various display devices, such as a plasma display panel (PDP) and an organic EL (Electro Luminescence) device, and various other electronic apparatuses.

According to the exemplary embodiments of the present invention, the filtering circuit including the bridge capacitor connected between a plurality of power terminals is provided in the voltage generating module. The voltage generating module allows sharing of capacitance through the bridge capacitor and, therefore, noisy ripples of the output voltage from the power terminals are offset and removed. As a result, stable power with minimal noise can be supplied, the entire system can stably operate, and a lifespan of a product can be improved.

According to exemplary embodiments of the present invention, even if an antenna for wireless communication is arranged close to the voltage generating module or power lines connected to the voltage generating module, signal interference at the antenna can be avoided because the power generated by the voltage generating module and supplied through the power lines has minimal noise and is stabilized. Therefore, the communication functions are improved, so that a user can enjoy a stable communication environment.

Although exemplary embodiments of the invention have been disclosed for illustrative purposes, those of ordinary skill in the art will appreciate that various modifications, additions and substitutions are possible, without departing from the scope and spirit of the invention, as disclosed in the accompanying claims.

What is claimed is:

1. A power generating module, comprising:
a first power terminal to which a first voltage is supplied;
a second power terminal to which a second voltage generated by a regulator is supplied; and
a filtering unit including a bridge capacitor connected between the first and the second power terminals.

2. The power generating module of claim 1,
wherein the filtering unit further comprises a resistor connected in parallel with the bridge capacitor.

3. The power generating module of claim 1, further comprising:
at least one of a first bypass capacitor connected to an input of the regulator, and a second bypass capacitor connected to an output of the regulator.

4. The power generating module of claim 3,
wherein one end of each of the first and second bypass capacitors is grounded.

5. The power generating module of claim 4,
wherein the other end of the second bypass capacitor is connected to the bridge capacitor.

6. The power generating module of claim 1,
wherein the first voltage comprises an alternating current component.

7. A display device, comprising:
a display panel for displaying an image; and
a power generating module for supplying a plurality of driving voltages for driving the display panel,
wherein the voltage generating module includes:
a first power terminal to which first voltage is supplied;
a second power terminal to which second voltage is supplied; and
a filtering unit including a bridge capacitor connected between the first power terminal and the second power terminal.

8. The display device of claim 7,
wherein the second voltage is generated by a regulator, and the first voltage is divided and input to the regulator.

9. The display device of claim 8, further comprising at least one of a first bypass capacitor connected to an input of the regulator, and a second bypass capacitor connected to an output of the regulator.

10. The display device of claim 9,
wherein one end of each of the first and second bypass capacitors is grounded.

11. The display device of claim 10,
wherein the other end of the second bypass capacitor is connected to the bridge capacitor.

12. The display device of claim 7,
wherein the filtering unit further comprises a resistor connected in parallel with the bridge capacitor.

13. The display device of claim 7,
wherein the display panel includes a liquid crystal layer.

14. An electronic apparatus, comprising:
a display panel for displaying an image;
a power generating module for supplying a plurality of driving voltages for driving the display panel;
at least one antenna provided at an outside region of the display panel;
a communication module for processing a radio signal received by the at least one antenna,
wherein the power generating module includes:
a first power terminal to which a first voltage is supplied;
a second power terminal to which a second voltage is supplied; and
a filtering unit including a bridge capacitor connected between the first power terminal and the second power terminal.

15. The electronic apparatus of claim 14,
wherein the communication module comprises a first communication module for a wireless wide area network, and a second communication module for a wireless local area network.

16. The electronic apparatus of claim 14,
wherein the filtering unit further comprises a resistor connected in parallel with the bridge capacitor.

17. The electronic apparatus of claim 14,
wherein the display panel and the antenna are provided in a single monitor.
